(19) United States
(12) Patent Application Publication
(10) Pub. No.: US 2019/0039466 A1
(43) Pub. Date: Feb. 7, 2019

(54) CHARGING CONTROL METHOD, ELECTRIC VEHICLE AND CHARGING APPARATUS USING THE SAME

(71) Applicants: Hyundai Motor Company, Seoul (KR); Kia Motors Corporation, Seoul (KR)

(72) Inventors: Taek Hyun Jung, Hwaseong (KR); Jae Yong Seong, Hwaseong (KR); Jin Su Jang, Hwaseong (KR)

(21) Appl. No.: 16/055,360

(22) Filed: Aug. 6, 2018

(30) Foreign Application Priority Data
Aug. 7, 2017 (KR) 10-2017-0099865
Jul. 10, 2018 (KR) 10-2018-0080102

(51) Int. Cl. B60L 11/18; H02J 50/60; H02J 50/10; H02J 7/02

(52) U.S. Cl. CPC B60L 11/182; H02J 50/60; H02J 7/025; H02J 50/10; B60L 11/184

(57) ABSTRACT

A charging control method performed by an electric vehicle (EV) configured to receive power wirelessly from a charging apparatus may include: detecting a presence of an occupant in the EV; detecting a presence of an implantable medical device (IMD) in the EV; determining a charging mode among a plurality of predefined charging modes according to at least one of the presence of the occupant and the presence of the IMD; transmitting information indicating the determined charging mode to the charging apparatus. The charging apparatus can activate a wireless power transfer (WPT) procedure in which power is wirelessly transmitted to the EV in accordance with the determined charging mode.

### CROSS-REFERENCE TO RELATED APPLICATION

The present application claims the benefit of priority to Korean Patent Application No. 10-2017-0099865, filed on Aug. 7, 2017 in the Korean Intellectual Property Office (KIPO), and Korean Patent Application No. 10-2018-0080102, filed on Jul. 10, 2018 in the KIPO, the entire contents of which are incorporated herein by reference.

### TECHNICAL FIELD

The present disclosure relates to a charging control method, and an electric vehicle (EV) and charging control apparatus using the same, and more specifically, to a method for controlling wireless charging according to a presence and a status of an occupant in the EV, as well as an EV and a control charging apparatus using the same.

### BACKGROUND

An electric vehicle (EV) charging system may be defined as a system for charging a high-voltage battery mounted in an EV using power of an energy storage device (e.g., a battery) or a power grid of a commercial power source. The EV charging system may have various forms according to the type of EV. For example, the EV charging system may be classified into a conductive-type using a charging cable and a non-contact wireless power transfer (WPT) type (also referred to as an “inductive-type”).

Electromagnetic waves may be generated during WPT. Such electromagnetic waves may adversely affect a human body. In particular, patients with an implanted medical device (IMD), such as a pacemaker to treat heart disease, may be affected by the magnetic fields generated during WPT. The patient's condition may become dangerous as a result.

Accordingly, the Society of Automotive Engineers (SAE) J2954, which is one of international standards related to the inductive-type EV charging technologies, specifies electromagnetic safety (EMF) limits for regions where passengers may be present inside or outside the EV. In conventional EV charging systems, when charging starts, electric power corresponding to the maximum capacity of the EV and the charging apparatus is constantly transferred within a range satisfying the EMF limits, but the charging may be stopped when a passenger is detected in the vicinity. However, the conventional EV charging systems have a disadvantage because rapid power transfer cannot be achieved under such limits.

### SUMMARY

In order to solve the above problems, embodiments of the present disclosure provide a wireless charging control method, an EV using the wireless charging control method, a wireless charging apparatus using the wireless charging control method, and a wireless charging control apparatus for the EV.

According to embodiments of the present disclosure, a charging control method performed by an EV receiving power from a charging apparatus may include: detecting a presence of an occupant in the EV; detecting a presence of an implantable medical device (IMD) in the EV; determining a charging mode among a plurality of predefined charging modes according to at least one of the presence of the occupant and the presence of the IMD; transmitting information indicating the determined charging mode to the charging apparatus. The charging apparatus may activate a wireless power transfer (WPT) procedure in which power is wirelessly transmitted to the EV in accordance with the determined charging mode.

The plurality of predefined charging modes may include at least one protective charging mode for a situation in which the presence of the occupant is detected in the EV and a maximum charging mode for a situation in which the presence of the occupant is not detected in the EV.

The at least one protective charging mode may include a first protective charging mode for performing the WPT procedure within a range defined by an electromagnetic safety (EMF) regulation when the presence of the occupant is detected in the EV; and a second protective charging mode for performing the WPT procedure within a range defined by an IMD regulation when the presence of the IMD is detected in the EV.

The EMF regulation and the IMD regulation may be specified by the SAE J2954 standard.

The detecting of the presence of the occupant in the EV may comprise receiving a radio frequency (RF) signal or a low frequency (LF) signal transmitted by a smart key, or receiving a signal from a seat sensor equipped in the EV.

The charging control method may further comprise detecting a foreign object in an area surrounding a transmission pad of the charging apparatus or an area surrounding a reception pad of the EV; and in response to detecting the foreign object in the area surrounding the transmission pad or the area surrounding the reception pad, stopping the WPT procedure immediately.

Furthermore, in accordance with embodiments of the present disclosure, an EV may include: a seat sensor; at least one communication module configured to communicate with a charging apparatus, a smart key, and an implantable medical device (IMD); a charging module including a reception pad communicatively coupled with a transmission pad of the charging apparatus and configured to receive power wirelessly from the transmission pad through the reception pad; at least one processor; and a memory storing at least one instruction executable by the at least one processor. The at least one instruction may be configured to cause the at least one processor to: detect a presence of an occupant in the EV based on a signal received through the at least one communication module or the seat sensor; detect a presence of the IMD in the EV based on a signal received through the at least one communication module; determine a charging mode among a plurality of predefined charging modes according to at least one of the presence of the occupant and the presence of the IMD; and transmit information indicating the determined charging mode to the charging apparatus through the at least one communication module. The charging apparatus may activate a wireless power transfer (WPT) procedure in which power is wirelessly transmitted to the EV in accordance with the determined charging mode.

The plurality of predefined charging modes may include at least one protective charging mode for a situation in which the presence of the occupant is detected in the EV and a maximum charging mode for a situation in which the presence of the occupant is not detected in the EV.

The at least one protective charging mode may include a first protective charging mode for performing the WPT procedure within a range defined by an electromagnetic safety (EMF) regulation when the presence of the occupant is detected in the EV; and a second protective charging mode for performing the WPT procedure within a range defined by an IMD regulation when the presence of the IMD is detected in the EV.

The EMF regulation and the IMD regulation may be specified by Society of Automotive Engineer (SAE) J2954 standard.

The at least one instruction may be further configured to cause the at least one processor to immediately stop the WPT procedure in response to detecting a foreign object in an area surrounding a transmission pad of the charging apparatus or an area surrounding a reception pad of the EV.

The at least one communication module may include a radio frequency (RF) communication module configured to receive an RF signal from the smart key or the IMD and to process the RF signal; and a low frequency (LF) communication module configured to transmit an LF signal to the smart key and to receive an LF signal from the smart key.

Furthermore, in accordance with embodiments of the present disclosure, a charging apparatus may include: a communication module configured to communicate with an electric vehicle (EV); a power transfer module including a transmission pad communicatively coupled with a reception pad of the EV and configured to transmit power wirelessly to the EV through the transmission pad; at least one processor; and a memory storing at least one instruction executable by the at least one processor. The at least one instruction may be configured to cause the at least one processor to activate a wireless power transfer (WPT) procedure according to a charging mode determined by the EV among a plurality of predefined charging modes based on at least one of a presence of an occupant in the EV and a presence of an implantable medical device (IMD) in the EV.

The plurality of predefined charging modes may include at least one protective charging mode for a situation in which the presence of the occupant is detected in the EV and a maximum charging mode for a situation in which the presence of the occupant is not detected in the EV.

The at least one protective charging mode may include a first protective charging mode for performing the WPT procedure within a range defined by an electromagnetic safety (EMF) regulation when the presence of the occupant is detected in the EV; and a second protective charging mode for performing the WPT procedure within a range defined by an IMD regulation when the presence of the IMD is detected in the EV.

The EMF regulation and the IMD regulation may be specified by the SAE J2954 standard.

The at least one instruction may be further configured to cause the at least one processor to immediately stop the WPT procedure in response to detecting a foreign object in an area surrounding a transmission pad of the charging apparatus or an area surrounding a reception pad of the EV.

Furthermore, in accordance with embodiments of the present disclosure, a charging control apparatus controlling WPT from a charging apparatus to an EV may include: at least one processor; and a memory storing at least one instruction executable by the at least one processor. The at least one instruction is configured to cause the at least one processor to: detect a presence of an occupant in the EV based on a signal received from a seat sensor in the EV or a signal received from a smart key; detect a presence of an implantable medical device (IMD) in the EV based on a signal received from the IMD; determine a charging mode among a plurality of predefined charging modes according to at least one of the presence of the occupant and the presence of the IMD; and transmit information indicating the determined charging mode to the charging apparatus through the at least one communication module. The charging apparatus may activate a wireless power transfer (WPT) procedure in which power is wirelessly transmitted to the EV in accordance with the determined charging mode.

The plurality of predefined charging modes may include at least one protective charging mode for a situation in which the presence of the occupant is detected in the EV and a maximum charging mode for a situation in which the presence of the occupant is not detected in the EV.

The at least one protective charging mode may include a first protective charging mode for performing the WPT procedure within a range defined by an electromagnetic safety (EMF) regulation when the presence of the occupant is detected in the EV; and a second protective charging mode for performing the WPT procedure within a range defined by an IMD regulation when the presence of the IMD is detected in the EV.

According to the embodiments of the present disclosure, when a passenger or a driver is not present within range of the adverse effect of the electromagnetic field caused by WPT, the power amount of the WPT can be increased to shorten the time required for charging to the EV. Therefore, the power amount of the WPT can be flexibly varied through detection of the driver status around the WPT system, thereby achieving quick charging while adhering to the EMF and IMD regulations at the same time.

### BRIEF DESCRIPTION OF DRAWINGS

Embodiments of the present disclosure will become more apparent by describing in detail embodiments of the present disclosure with reference to the accompanying drawings, in which:

FIG. 1 is a conceptual diagram illustrating an example of a WPT system;

FIG. 2 is a top view illustrating EMF regions to explain EMF limits;

FIG. 3 is a front view illustrating EMF regions to explain EMF limits;

FIG. 4 is a table listing reference levels of EMF exposure;

FIG. 5 is a table listing basic restricting levels of EMF exposure;

FIG. 6 is a table listing magnetic field limits of a pacemaker/IMD for each region in vehicle interior and exterior;

FIG. 7 is a conceptual diagram illustrating a wireless charging control system according to embodiments of the present disclosure;

FIG. 8 is a diagram illustrating a frequency spectrum used for IMDs and a frequency spectrum of vehicle RF signals;

FIG. 9 is a conceptual diagram illustrating an IMD monitoring system;

FIG. 10 is a conceptual diagram illustrating an example of charging power control for at least one charging mode according to embodiments of the present disclosure;

FIG. 11 is an operational flowchart illustrating a charging control method according to embodiments of the present disclosure;

FIG. 12 is a block diagram illustrating an EV according to embodiments of the present disclosure;

FIG. 13 is a diagram illustrating a structure of a frame used for LF communications applicable to embodiments of the present disclosure;

FIG. 14 is a diagram illustrating a structure of a frame used for RF communications applicable to embodiments of the present disclosure;

FIG. 15 is a diagram illustrating a timing cycle of a pacemaker applicable to embodiments of the present disclosure; and

FIG. 16 is a block diagram illustrating a charging apparatus according to embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein. While describing the respective drawings, like reference numerals designate like elements.

It will be understood that although the terms “first,” “second,” etc. may be used herein to describe various components, these components should not be limited by these terms. These terms are used merely to distinguish one element from another. For example, without departing from the scope of the present disclosure, a first component may be designated as a second component, and similarly, the second component may be designated as the first component. The term “and/or” include any and all combinations of one of the associated listed items.

It will be understood that when a component is referred to as being “connected to” another component, it can be directly or indirectly connected to the other component. That is, for example, intervening components may be present. On the contrary, when a component is referred to as being “directly connected to” another component, it will be understood that there is no intervening components.

Terms are used herein only to describe the embodiments but not to limit the present disclosure. Singular expressions, unless defined otherwise in contexts, include plural expressions. In the present specification, terms of “comprise” or “have” are used to designate features, numbers, steps, operations, elements, components or combinations thereof disclosed in the specification as being present but not to exclude possibility of the existence or the addition of one or more other features, numbers, steps, operations, elements, components, or combinations thereof.

All terms including technical or scientific terms, unless being defined otherwise, have the same meaning generally understood by a person of ordinary skill in the art. It will be understood that terms defined in dictionaries generally used are interpreted as including meanings identical to contextual meanings of the related art, unless definitely defined otherwise in the present specification, are not interpreted as being ideal or excessively formal meanings.

According to embodiments of the present disclosure, an EV charging system may be defined as a system for charging a high-voltage battery mounted in an EV using power of an energy storage device (e.g., a battery) or a power grid of a commercial power source. The EV charging system may have various forms according to the type of EV. For example, the EV charging system may be classified into a conductive-type using a charging cable and a non-contact wireless power transfer (WPT) type (also referred to as an “inductive-type”). A power source may include a residential or public electrical service, a generator utilizing vehicle-mounted fuel, or the like.

Terms used in the present disclosure are defined as follows.

“Electric Vehicle (EV)”: An automobile, as defined in 49 CFR 523.3, intended for highway use, powered by an electric motor that draws current from an on-vehicle energy storage device, such as a battery, which is rechargeable from an off-vehicle source, such as residential or public electric service or an on-vehicle fuel powered generator. The EV may be four or more wheeled vehicle manufactured for use primarily on public streets, roads.

The EV may be referred to as an electric car, an electric automobile, an electric road vehicle (ERV), a plug-in vehicle (PV), a plug-in vehicle (xEV), etc., and the xEV may be classified into a plug-in all-electric vehicle (BEV), a battery electric vehicle, a plug-in electric vehicle (PEV), a hybrid electric vehicle (HEV), a hybrid plug-in electric vehicle (HPEV), a plug-in hybrid electric vehicle (PHEV), etc.

“Plug-in Electric Vehicle (PEV)”: An Electric Vehicle that recharges the on-vehicle primary battery by connecting to the power grid.

“Plug-in vehicle (PV)”: An electric vehicle rechargeable through wireless charging from an electric vehicle supply equipment (EVSE) without using a physical plug or a physical socket.

“Heavy duty vehicle (H.D. Vehicle)”: Any four-or more wheeled vehicle as defined in 49 CFR 523.6 or 49 CFR 37.3 (bus).

“Light duty plug-in electric vehicle”: A three or four-wheeled vehicle propelled by an electric motor drawing current from a rechargeable storage battery or other energy devices for use primarily on public streets, roads and highways and rated at less than 4,545 kg gross vehicle weight.

“Wireless power charging system (WCS)”: The system for wireless power transfer and control between the GA and VA including alignment and communications. This system transfers energy from the electric supply network to the electric vehicle electromagnetically through a two-part loosely coupled transformer.

“Wireless power transfer (WPT)”: The transfer of electrical power from the AC supply network to the electric vehicle by contactless means.

“Utility”: A set of systems which supply electrical energy and may include a customer information system (CIS), an advanced metering infrastructure (AMI), rates and revenue system, etc. The utility may provide the EV with energy through rates table and discrete events. Also, the utility may provide information about certification on EVs, interval of power consumption measurements, and tariff.

“Smart charging”: A system in which EVSE and/or PEV communicate with power grid in order to optimize charging ratio or discharging ratio of EV by reflecting capacity of the power grid or expense of use.

“Automatic charging”: A procedure in which inductive charging is automatically performed after a vehicle is located in a proper position corresponding to a primary charger assembly that can transfer power. The automatic charging may be performed after obtaining necessary authentication and right.

“Interoperability”: A state in which components of a system interwork with corresponding components of the system in order to perform operations aimed by the system. Also, information interoperability may mean capability that two or more networks, systems, devices, applications, or components can efficiently share and easily use information without causing inconvenience to users.

“Inductive charging system”: A system transferring energy from a power source to an EV through a two-part gapped core transformer in which the two halves of the transformer, primary and secondary coils, are physically separated from one another. In the present disclosure, the inductive charging system may correspond to an EV power transfer system.

“Inductive coupler”: The transformer formed by the coil in the GA Coil and the coil in the VA Coil that allows power to be transferred with galvanic isolation.

“Inductive coupling”: Magnetic coupling between two coils. In the present disclosure, coupling between the GA Coil and the VA Coil.

“Ground assembly (GA)”: An assembly on the infrastructure side consisting of the GA Coil, a power/frequency conversion unit and GA controller as well as the wiring from the grid and between each unit, filtering circuits, housing(s) etc., necessary to function as the power source of wireless power charging system. The GA may include the communication elements necessary for communication between the GA and the VA.

“Vehicle assembly (VA)”: An assembly on the vehicle consisting of the VA Coil, rectifier/power conversion unit and VA controller as well as the wiring to the vehicle batteries and between each unit, filtering circuits, housing(s), etc., necessary to function as the vehicle part of a wireless power charging system. The VA may include the communication elements necessary for communication between the VA and the GA.

The GA may be referred to as a primary device (PD), and the VA may be referred to as a secondary device (SD).

“Primary device”: An apparatus which provides the contactless coupling to the secondary device. That is, the primary device may be an apparatus external to an EV. When the EV is receiving power, the primary device may act as the source of the power to be transferred. The primary device may include the housing and all covers.

“Secondary device”: An apparatus mounted on the EV which provides the contactless coupling to the primary device. That is, the secondary device may be installed in the EV. When the EV is receiving power, the secondary device may transfer the power from the primary to the EV. The secondary device may include the housing and all covers.

“GA controller”: The portion of the GA which regulates the output power level to the GA Coil based on information from the vehicle.

“VA controller”: The portion of the VA that monitors specific on-vehicle parameters during charging and initiates communication with the GA to control output power level.

The GA controller may be referred to as a primary device communication controller (PDCC), and the VA controller may be referred to as an electric vehicle communication controller (EVCC).

“Magnetic gap”: The vertical distance between the plane of the higher of the top of the litz wire or the top of the magnetic material in the GA Coil to the plane of the lower of the bottom of the litz wire or the magnetic material in the VA Coil when aligned.

“Ambient temperature”: The ground-level temperature of the air measured at the subsystem under consideration and not in direct sun light.

“Vehicle ground clearance”: The vertical distance between the ground surface and the lowest part of the vehicle floor pan.

“Vehicle magnetic ground clearance”: The vertical distance between the plane of the lower of the bottom of the litz wire or the magnetic material in the VA Coil mounted on a vehicle to the ground surface.

“VA Coil magnetic surface distance”: the distance between the plane of the nearest magnetic or conducting component surface to the lower exterior surface of the VA coil when mounted. This distance includes any protective coverings and additional items that may be packaged in the VA Coil enclosure.

The VA coil may be referred to as a secondary coil, a vehicle coil, or a receive coil. Similarly, the GA coil may be referred to as a primary coil, or a transmit coil.

“Exposed conductive component”: A conductive component of electrical equipment (e.g., an electric vehicle) that may be touched and which is not normally energized but which may become energized in case of a fault.

“Hazardous live component”: A live component, which under certain conditions can give a harmful electric shock.

“Live component”: Any conductor or conductive component intended to be electrically energized in normal use.

“Direct contact”: Contact of persons with live components. (See IEC 61440)

“Indirect contact”: Contact of persons with exposed, conductive, and energized components made live by an insulation failure. (See IEC 61140)

“Alignment”: A process of finding the relative position of primary device to secondary device and/or finding the relative position of secondary device to primary device for the efficient power transfer that is specified. In the present disclosure, the alignment may direct to a fine positioning of the wireless power transfer system.

“Pairing”: A process by which a vehicle is correlated with the unique dedicated primary device, at which it is located and from which the power will be transferred. Pairing may include the process by which a VA controller and a GA controller of a charging spot are correlated. The correlation/association process may include the process of establishment of a relationship between two peer communication entities.

“Command and control communication”: The communication between the EV supply equipment and the EV exchanges information necessary to start, control and terminate the process of WPT.

“High level communication (HLC)”: HLC is a special kind of digital communication. HLC is necessary for additional services which are not covered by command & control communication. The data link of the HLC may use a power line communication (PLC), but it is not limited.

“Low power excitation (LPE)”: LPE means a technique of activating the primary device for the fine positioning and pairing so that the EV can detect the primary device, and vice versa.

“Service set identifier (SSID)”: SSID is a unique identifier consisting of 32-characters attached to a header of a packet transmitted on a wireless LAN. The SSID identifies the basic service set (BSS) to which the wireless device attempts to connect. The SSID distinguishes multiple wireless LANs. Therefore, all access points (APs) and all terminal/station devices that want to use a specific wireless LAN can use the same SSID. Devices that do not use a unique SSID are not able to join the BSS. Since the SSID is shown as plain text, it may not provide any security features to the network.

“Extended service set identifier (ESSID)”: ESSID is the name of the network to which one desires to connect. It is similar to SSID but can be a more extended concept.

“Basic service set identifier (BSSID)”: BSSID consisting of 48 bits is used to distinguish a specific BSS. In the case of an infrastructure BSS network, the BSSID may be medium access control (MAC) of the AP equipment. For an independent BSS or ad hoc network, the BSSID can be generated with any value.

The charging station may comprise at least one GA and at least one GA controller configured to manage the at least one GA. The GA may comprise at least one wireless communication device. The charging station may mean a place having at least one GA, which is installed in home, office, public place, road, parking area, etc.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. The controller may control operation of units, modules, parts, or the like, as described herein. Moreover, it is understood that the below methods may be executed by an apparatus comprising the controller in conjunction with one or more other components, as would be appreciated by a person of ordinary skill in the art.

According to embodiments of the present disclosure, a light load driving or light load operation may include, for example, charging a high voltage battery with a charging voltage lower than a predetermined rated voltage in the latter half of charging for the high voltage battery connected to the VA in the WPT system. Also, the light load operation may include a case in which the high-voltage battery of EV is charged at a relatively low voltage and at a low speed by using a low-speed charger such as a household charger.

Embodiments of the present disclosure are related to a method for facilitating wireless connection between an EV and a charging apparatus such as electric vehicle supply equipment (EVSE). Currently, most of the EV charging is performed in the conductive manner, but the inductive charging is also continuously being developed. Even in the case of using the conductive charging, data communications between the EV and the charging apparatus can be performed based on wireless communications.

Currently, standards for wireless charging are being developed to consider communications with the grid (i.e., vehicle-to-grid (V2G) communications) beyond the communications between the EV and the EVSE. For example, the international organization for standardization (ISO) 15118 (e.g., ISO 15118-6, 7 and 8) defines communication protocols for the wireless charging. The embodiments of the present disclosure can provide an optimal communication method for wireless charging.

Hereinafter, embodiments according to the present disclosure will be explained in detail by referring to accompanying figures.

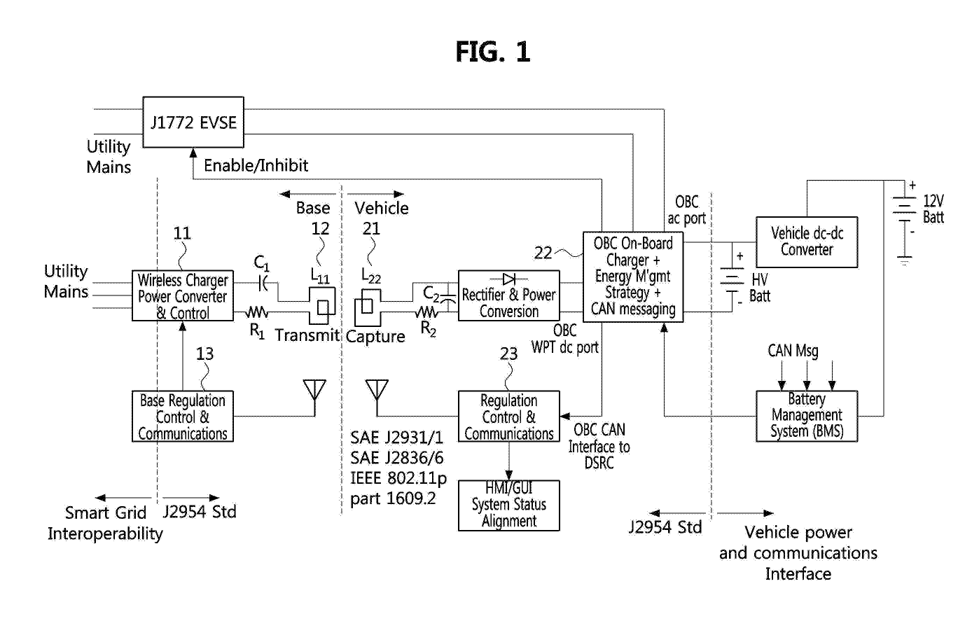

FIG. 1 is a conceptual diagram illustrating an example of a WPT system.

As described above, an EV charging system may include a conductive charging system using a charging cable and a contact-less WPT system, but may not be restricted thereto. The EV charging system may basically be defined as a system for charging a high-voltage battery mounted on an EV by using power of an energy storage device or a power grid of a commercial power source. Such the EV charging system may have various forms according to the type of EV.

The SAE TIR J2954, a leading standard for the EV wireless charging, establishes guidelines that define interoperability, electromagnetic compatibility, minimum performance, safety, and acceptance criteria for testing for wireless charging of light-duty EVs and PEVs.

According to the SAE TIR J2954, referring to FIG. 1, a WPT system for an EV (alternatively referred to herein as an “EV WPT system”) may comprise a utility interface, a high frequency power converter, coupled coils, a rectifier, a filter, an optional regulator, and communication devices between a vehicle energy charge/store system and the power converter connected to the utility. The utility interface may be similar to a traditional EVSE connection for single-phase or three-phase AC power.

The EV WPT system may roughly comprise three blocks. The first block may comprise a GA coil 12, a power converter 11 connected to the grid, and a communication module 13 having a communication link with the vehicle system. The second block may comprise a VA coil 21 having rectifying and filtering elements, a charging control electronic device 22 for regulation, safety, and shutdown, and a communication module 23 having a communication link with the charging station side. The third block may comprise a secondary energy storage system, a battery management system (BMS), and an in-vehicle communication (e.g., CAN, LIN, etc.) module required for exchanging information on a battery state-of-charge (SOC) and a charging rate, and other necessary information.

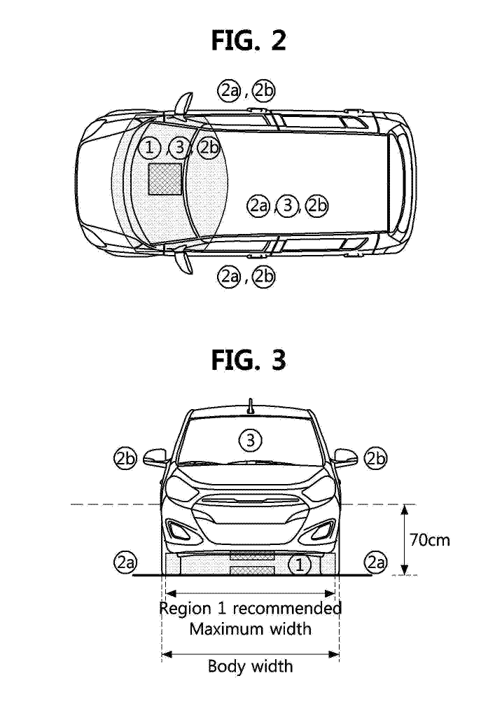

FIG. 2 is a top view illustrating EMF regions to explain EMF limits, and FIG. 3 is a front view illustrating EMF regions to explain EMF limits.

As shown in FIGS. 2 and 3, four physical regions may be defined for facilitate EMF safety management of the wireless charging system.

For example, a region 1 may be an entire area underneath the vehicle, including and surrounding the wireless power assemblies (i.e., both of the VA and the GA). The region 1 shall not be extended beyond lower body structure edges (e.g., rocker panels or lower edges of bumpers).

Also, a region 2a may be a region around the vehicle, at heights less than 70 cm above ground. The region 2b may additionally include areas under the vehicle. Also, a region 2b may be a region around the vehicle, at heights equal to or greater than 70 cm above ground. Also, a region 3 may be a vehicle interior.

The depicted shape and extent of the region 1 is an example only. The EMF management shall be applicable for all operational conditions such as a coupler offset or other system variations which may affect the worst case exposure. Also, the boundaries of the region 1 may be redefined for different system, vehicle configurations, or operating conditions as long as EMF safety management principles and requirements are met for each configuration and condition.

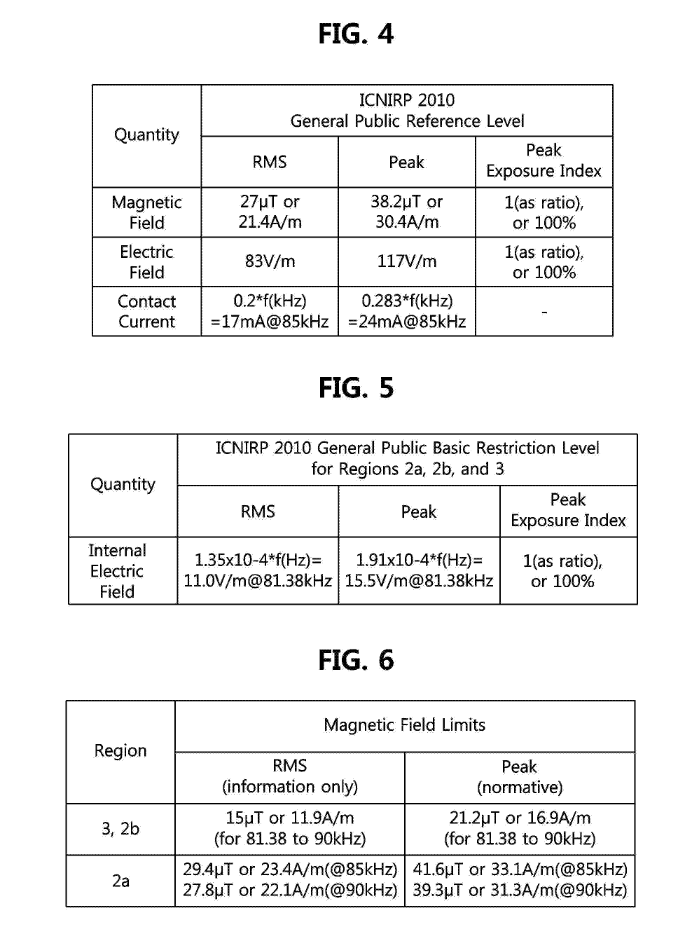

FIG. 4 is a table listing reference levels of EMF exposure, and FIG. 5 is a table listing basic restricting levels of EMF exposure.

Electric and magnetic fields and contact currents in the regions 2a, 2b and 3 shall comply with the guidelines for general public EMF exposure referenced in International Commission on Non-Ionizing Radiation Protection (ICNIRP) 2010.

In the table of FIG. 4, the general public reference levels may be given for EMF emissions in the standard operating frequency of band of 81.38 to 90 kHz. Compliance with the reference levels listed in the table of FIG. 4 ensures compliance with the basic restriction levels listed in the table of FIG. 5.

Due to a possibility of low frequency modulation of the fields or contact current, an EMF assessment should utilize peak detection. Demonstration of compliance with a peak exposure limit additionally ensures compliance with a root mean square (RMS) exposure limit.

FIG. 6 is a table listing magnetic field limits of a pacemaker/IMD for each region in vehicle interior and exterior.

As usual, it is expected that pacemakers and implanted neuro-stimulators operate as designed in 81.38 to 90 kHz fields below 21.2 μT peak. Thus, magnetic fields in the regions 3 and 2b shown in FIGS. 2 and 3 shall be constrained to the corresponding peak levels specified in the table of FIG. 6.

That is, the magnetic field in the region 2a may be preferably less than 29.4 μT or 23.4 A/m, based on RMS, at 85 kHz, and preferably less than 27.8 μT or 22.1 A/m at 90 kHz. Also, the peak value is required to be less than 41.6 μT or 33.1 A/m at 85 kHz and 39.3 μT or 31.3 A/m at 90 kHz.

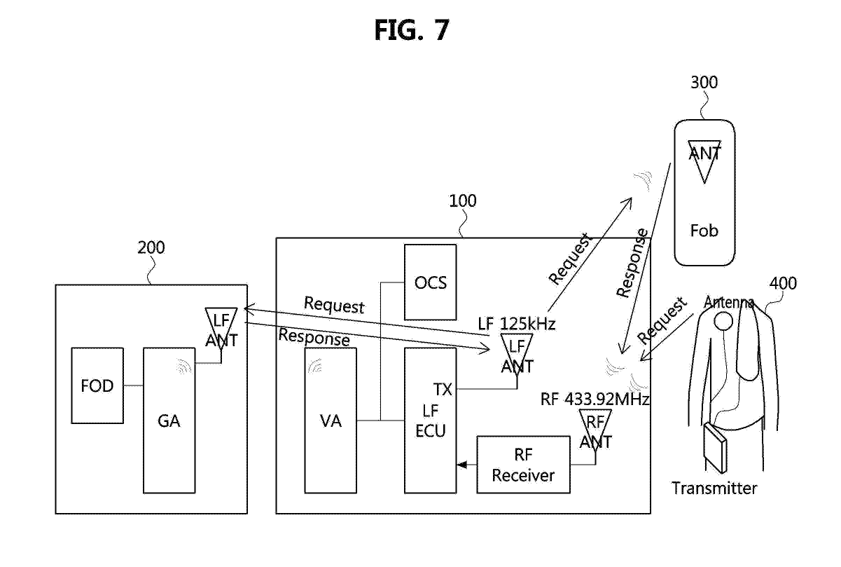

FIG. 7 is a conceptual diagram illustrating a wireless charging control system according to embodiments of the present disclosure.

As shown in FIG. 7, a wireless charging control system may include a vehicle 100 and a charging apparatus 200, and the vehicle 100 may communicate with a smart key 300 and an IMD 400 used by an occupant (e.g., driver or passenger) in the vehicle. The wireless charging control system according to an embodiment of the present disclosure can variably control the amount of power transfer depending on a presence of the occupant and the use of the IMD 400.

The vehicle 100 may determine the presence of the occupant in the vehicle through a seat sensor (e.g., an occupant classification system (OCS)), the smart key 300, or the like.

The vehicle 100 and the smart key 300 may perform bidirectional communications using a low frequency (LF) communication scheme or a radio frequency (RF) communication scheme. For example, the RF communication scheme may uses a frequency of 433.92 Mhz, and the LF communication scheme may use a frequency of 125 kHz and 134.2 kHz.

Here, the smart key system may provide, through the LF/RF communications, a passive entry function of opening or closing doors (i.e., door lock or unlock) or a trunk, and a passive engine starting function of starting an engine for a driver holding the smart key 300.

The IMD 400 may periodically communicate with an external apparatus (e.g., an external diagnostic apparatus or a remote transmitted to be described) through a communication device (i.e., an RF telemetry device). A wireless communication frequency band used for communications between the IMD and the external apparatus may be the same as or may overlap at least partly with the RF communication band used for communications between the vehicle and the smart key. Accordingly, a RF receiver of the vehicle 100 may receive and process both RF signals transmitted by the smart key 300 and RF signals transmitted by the IMD 400. Also, the vehicle may determine the presence of the IMD and the smart key (or, fob) through the RF receiver (a single RF receiver, if possible).

Meanwhile, the vehicle 100 may determine whether or not a transmission pad exists by using LF signals exchanged between the vehicle and a ground assembly in the charging apparatus 200.

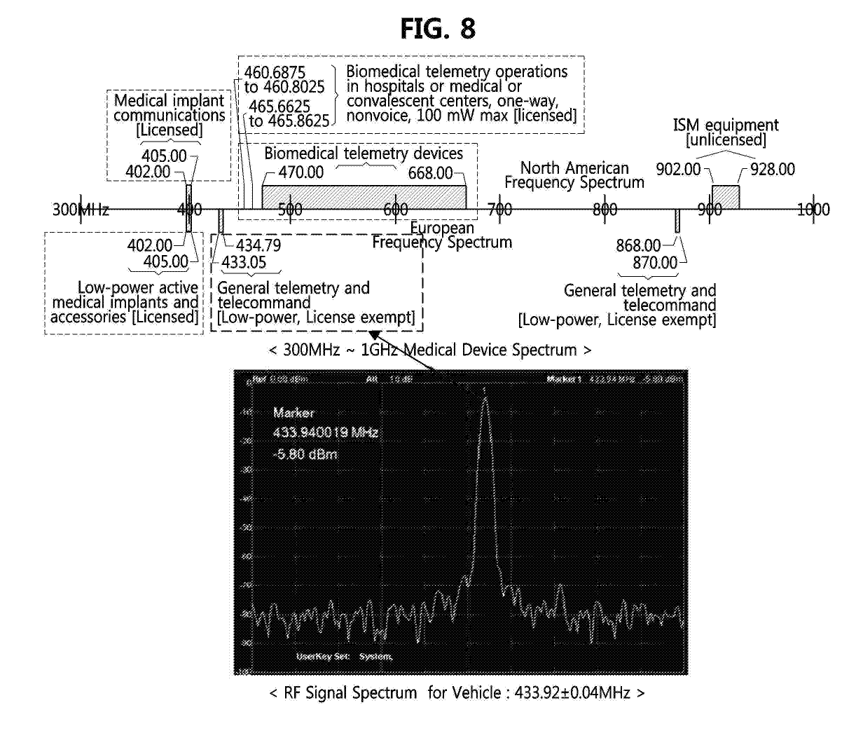

FIG. 8 is a diagram illustrating a frequency spectrum used for IMDs and a frequency spectrum of vehicle RF signals.

As shown in FIG. 8, a frequency used by a medical device may have a range of 300 MHz to 1 GHz. For medical implant communications of low-power active medical implants and accessories, a licensed frequency band of 402 MHz to 405 MHz may be used. Also, a low-power license-exempt frequency band of 434.79 MHz to 433.05 MHz may be used for general telemetry and telecommand

Meanwhile, a frequency used for the vehicle RF signals may have a range of 433.92±0.04 MHz, which is within the range of the frequency band used for the telemetry and telecommand of the medical device.

Thus, since the frequency band of the RF telemetry used for the IMD to communicate with the external apparatus overlaps the frequency spectrum of the vehicle RF signals, the RF receiver of the vehicle according to the present disclosure can receive signals transmitted by the IMD and the smart key, and process them.

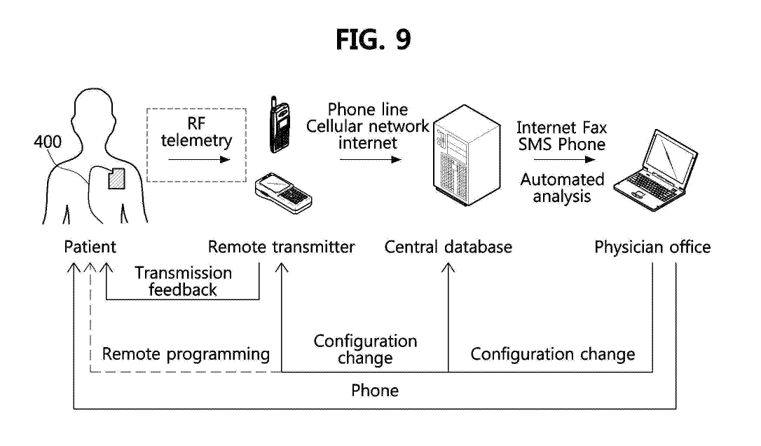

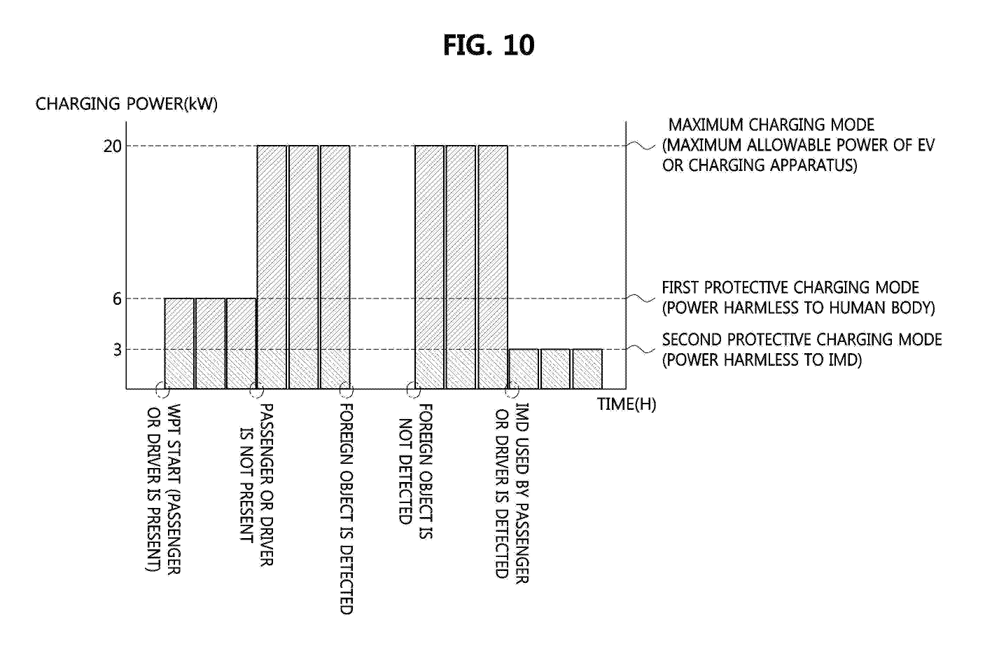

FIG. 9 is a conceptual diagram illustrating an IMD monitoring system.

The IMD is a human implantable medical device having a small computing platform in a programmable form that operates on a small battery, and can monitor a patient's health or perform medical therapy.

The IMD may include, for example, deep brain neurostimulators, gastric stimulators, foot drop implants, cochlear implants, cardiac defibrillators, cardiovascular implantable electronic device (CIED), insulin pumps, or the like.

Among these, the CIED may include, for example, a pacemaker, an implantable cardioverter-defibrillator (ICD), a cardiac resynchronization therapy device (CRT), an implantable loop recorder (ILR), and an implantable cardiovascular monitor (ICM), but is not limited to the listed devices.

As shown in FIG. 9, the IMD 400 may store its own information, information on disease and treatment information for the patient, information on the patient, information related to an associated medical center, condition history of the patient, treatment history of the patient, and the like.

At least a portion of the information stored in the IMD may be transmitted to a central database located at the medical center or the like via a remote transmitter. Here, communications using the RF telemetry device may be performed between the IMD and the remote transmitter. The EV or the charging control apparatus for the EV according to the present disclosure can detect a presence of the IMD by receiving an RF signal generated and transmitted periodically by the IMD.

The information transferred to the central database may be provided to medical staffs in the medical center or a separate physician office, and the medical staffs may change prescription for the patient and perform a treatment action for the patient, if necessary, through analysis of the transferred information.

FIG. 10 is a conceptual diagram illustrating an example of charging power control for at least one charging mode according to embodiments of the present disclosure.

According to embodiments of the present disclosure, WPT to the EV may be performed according to one of a plurality of predefined charging modes including, for example, a maximum charging mode and at least one protective charging mode, configured based on the presence or absence of at least one of the smart key and the IMD. The at least one protective charging mode may be further divided into two specific charging modes, for example. Thus, the plurality of predefined charging modes according to embodiments of the present disclosure may be classified into at least the following three modes.

First protective charging mode: a mode for performing WPT within a range defined by the EMF regulation (i.e., a range of power harmless to a human body of the passenger or the driver), which may be selected when a passenger or a driver is present.

Second protective charging mode: a mode for performing WPT within a range defined by the IMD regulation (i.e., a range of power harmless to the IMD), which may be selected when a signal of the IMD is detected.

Maximum charging mode: a mode for transferring a maximum allowable power of the EV or the charging apparatus, which may be selected when a passenger or a driver is not present.

Also, in a charging control method of the present disclosure, the WPT may be stopped when a foreign object is detected in “high-risk areas” such as a top part of the transmission or reception pad.

The graph illustrated in FIG. 10 may represent an example of change in a charging power based on events that occur over time according to an embodiment of the present disclosure.

In the example of FIG. 10, it may be assumed that a driver (or, a passenger) is present in a driver's seat when the WPT is started. When a driver (or, passenger) is present, the WPT may be performed in the first protective charging mode (i.e., considering the power regulation value harmless to the human body in general). For example, in the embodiment of FIG. 10, the charging power in the first protective charging mode may be 6 kW.

Then, when the driver (or, the passenger) gets off and there is no driver or passenger boarding the EV, the charging mode may be changed to the maximum charging mode, and the WPT may be performed with the maximum allowable power of the EV or the charging apparatus (e.g., 20 kW).

If a foreign object is detected in the “high-risk areas” (e.g., in an area surrounding a transmission pad of the charging apparatus or an area surrounding a reception pad of the EV) during WPT, the WPT may be stopped. If the foreign object is not detected in the high-risk areas, the charging mode may be maintained and the WPT may be continuously performed.

In case of detecting a driver (or, a passenger) using or wearing the IMD (e.g., pacemaker) during the WPT, the charging mode may be changed to the second protective charging mode, and the WPT may be performed within the transmission power regulation value which does not damage or give adverse effects to the IMD. For example, in the embodiment of FIG. 10, the charging power in the second protective charging mode may be 3 kW.

The embodiments of the present disclosure apply different charging modes in consideration of whether a driver (or, a passenger) is present in a vehicle, whether an IMD is present in a vehicle, and the like. Thus, as compared with the conventional charging technique of performing WPT at a constant charging power, it is possible to achieve a target state of charge (SOC) more efficiently and quickly, and time required for EV charging can be reduced.

Accordingly, an EV according to embodiments of the present disclosure can determine the driver's status (or, passenger's status) through the LF signal, the RF signal, the seat sensor signal, or the like, and select one of the charging modes to proceed with the WPT. Here, the driver's status may include whether or not the driver is present in the vehicle and whether or not the IMD is worn by the driver.

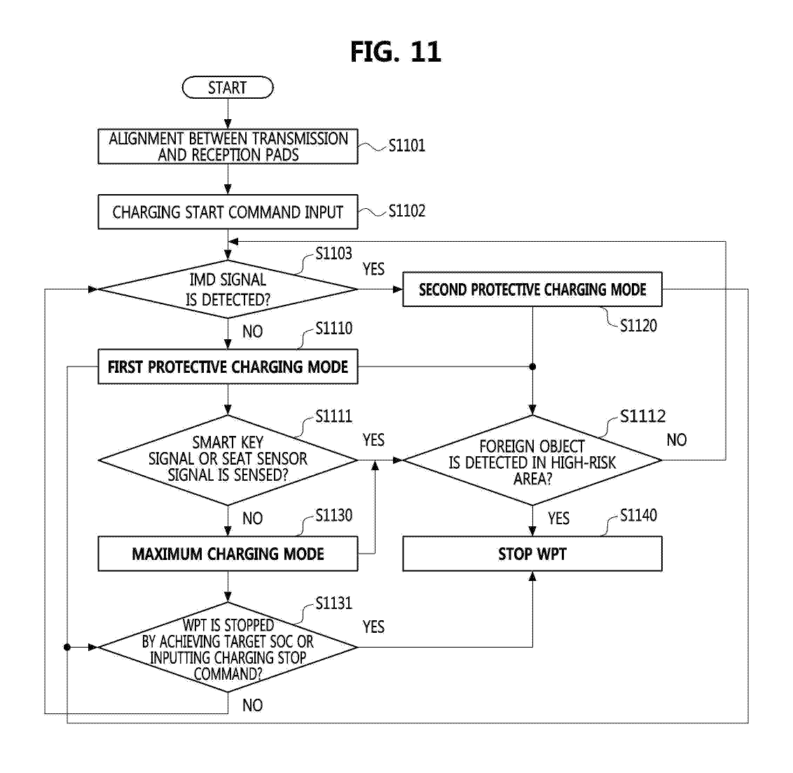

FIG. 11 is an operational flowchart illustrating a charging control method according to embodiments of the present disclosure.

The charging control method illustrated in FIG. 11 may be performed by at least one of the charging apparatus and the EV.

In order to perform the WPT, alignment between a reception pad of the EV and a transmission pad of the charging apparatus may be preceded (S1101). When a charging start command is inputted by a user (e.g., a driver or passenger of the EV, or an operator of the charging apparatus) after the transmission and reception pads are aligned (S1102), the EV may sense an IMD signal and determine whether a passenger or a user using an IMD is present in the EV (‘Yes’ in S1103). When the IMD signal is sensed, the WPT may be performed in the second protective charging mode (S1120). As described above, the second protective charging mode is the mode for performing the WPT within the range that does not deviate from the IMD regulation (i.e., a range of power harmless to the IMD). For example, the charging power in the second protective charging mode may be 3 kW.

On the other hand, when a driver or user using an IMD is not present in the EV (‘No’ in S1103), the WPT may be first performed in the first protective charging mode (S1110). As described above, the first protective charging mode is the mode for performing the WPT within the range that does not deviate from the EMF regulation of the general reference level (i.e., a range of power harmless to a human body of the passenger or the driver). For example, the charging power in the first protection charging mode may be 6 kW.

In the first protective charging mode, if an RF signal or an LF signal received from the smart key is not detected during the WPT or if a seat sensor signal is not sensed (‘No’ in S1111), the WPT may be performed in the maximum charging mode (S1130). As described above, the maximum charging mode is the mode for transferring the maximum allowable power of the EV or the charging apparatus. For example, the charging power in the maximum charging mode may be 20 kW.

If a target SOC is achieved through the first protective charging mode, the second protective charging mode, or the maximum charging mode (‘Yes’ in S1131), or if a charging stop command is inputted by the user, the WPT may be stopped S1140).

Meanwhile, if a foreign object is detected in the high-risk areas even during the WPT in the first protective charging mode, the second protective charging mode, or the maximum charging mode (S1112), the WPT may be stopped (S1140). The detection of the foreign object that may adversely affect the WPT between the transmission and reception pads may be performed by the EV or the charging apparatus.

The operation sequence of the charging control method illustrated in FIG. 11 is merely an example. That is, the steps of sensing the IMD signal, sensing the RF or LF signal or the seat sensor signal of the smart key, and detecting the foreign object in the high-risk area may be performed at the same time or with a different operation sequence, and the operation sequence of the subsequent steps thereof may also be changed.

Also, the steps of sensing the IMD signal and sensing the RF or LF signal of the smart key or the seat sensor signal may be performed by the EV, and a result of the steps may be notified to the charging apparatus. Also, the step of performing the WPT by determining the charging mode according to the result may be performed by the EV, or by the charging apparatus receiving the result notified the EV.

Meanwhile, when the charge control method illustrated in FIG. 11 is performed by the EV, the charge control method may comprise detecting a presence of an occupant (e.g., passenger or driver) in the EV; detecting a presence of an IMD in the EV; determining a charging mode according to presence or absence of the occupant and presence or absence of the IMD; and transmitting information on the determined charging mode to the charging apparatus.

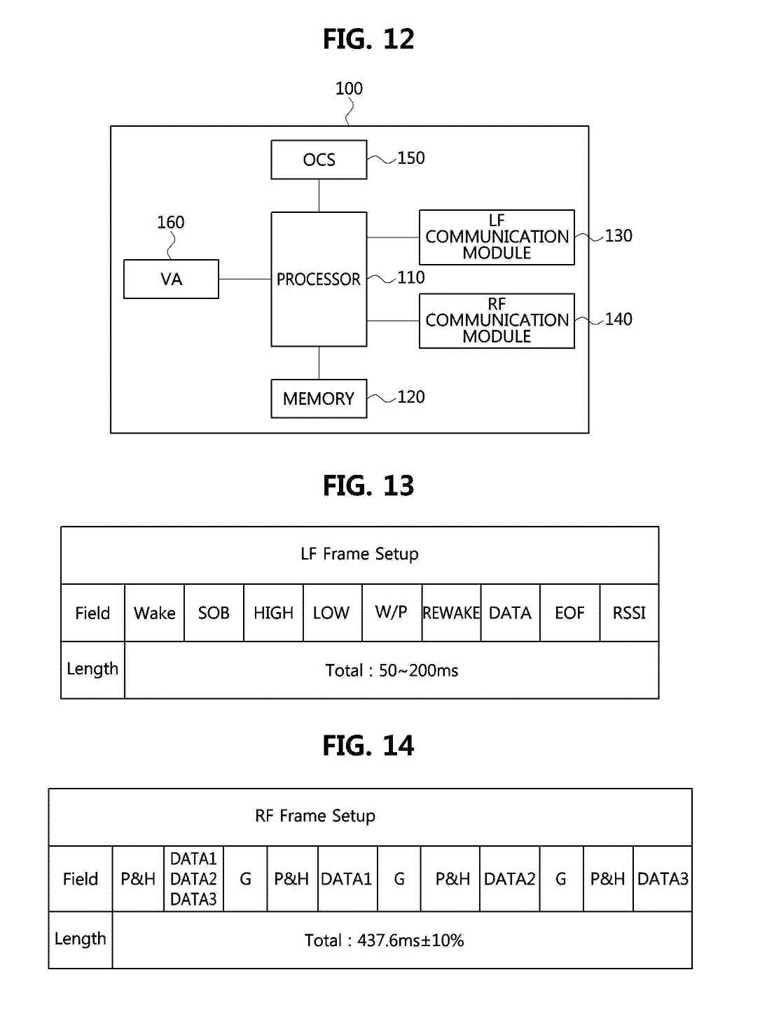

FIG. 12 is a block diagram illustrating an EV according to embodiments of the present disclosure.

As shown in FIG. 12, an EV 100 according to embodiments of the present disclosure may comprise at least one processor 110 and a memory 120. The EV 100 may also comprise communication modules 130 and 140, an OCS 150, and a VA 160.

The communication module may include an LF communication module 130 and an RF communication module 140, which perform communications with the charging apparatus, the smart key, or the IMD. For example, the LF communication module 130 may include an LF antenna, and may transmit, receive, and process LF signals with the smart key. The RF communication module 140 may include an RF antenna, and may transmit, receive and process RF signals from the IMD or the smart key.

The OCS 150 may be a seat sensor, for example, which is mounted on a driver's seat to sense a weight applied to the seat. The EV may determine whether a driver or a passenger is seated on the seat through a signal from the seat sensor.

The VA 160 may be an in-vehicle charging module including a reception pad that receives power output from a transmission pad by being associated with the transmission pad of the charging apparatus.

Meanwhile, the memory 120 may store at least one instruction executed by the at least one processor 110. The at least one instruction may be configured to, when executed by the at least one processor, cause the at least one processor to detect a presence of an occupant (e.g., a passenger or a driver) in the EV based on a signal received by a communication module or a signal sensed by a seat sensor; detect a presence of an IMD in the EV based on a signal received by a communication module; determine a charging mode according to presence or absence of the occupant and presence or absence of the IMD; and transmit information on the determined charging mode to the charging apparatus.

The at least one instruction may be further configured to cause the at least one processor to stop the WPT immediately upon detection of a foreign object proximate to a “high-risk area,” such as an area surrounding the transmission pad of the charging apparatus or an area surrounding the reception pad of the EV.

The charging mode may include at least one protective charging mode for a case that an occupant is present in the EV and a maximum charging mode for a case that an occupant is not present in the EV.

The at least one protective charging mode may include a first protective charging mode for performing WPT within a range that does not deviate from the EMF regulation of the general reference level, which may be selected when an occupant is present in the EV, and a second protective charging mode for performing WPT within a range that does not deviate from the IMD regulation (i.e., a range of power harmless to the IMD), which may be selected when a signal of the IMD is detected.

The EMF regulation and the IMD regulation may be configured as specified by the SAE J2954 standard.

Meanwhile, the at least one processor 110 and the memory 120 may constitute a charging control apparatus which is mounted in the EV and controls the WPT for the EV. Here, at least one instruction stored in the memory 120 may be configured to cause the at least one processor 110 to detect a presence of an occupant (e.g., passenger or driver) in the EV based on a signal received by a communication module or a signal sensed by a seat sensor; detect a presence of an IMD in the EV based on a signal received by a communication module; determine a charging mode according to presence or absence of the occupant and presence or absence of the IMD; and transmit information on the determined charging mode to the charging apparatus.

FIG. 13 is a diagram illustrating a structure of a frame used for LF communications applicable to embodiments of the present disclosure.

As described above, the LF communication module of the EV and the LF communication module of the charging apparatus may communicate with each other using the LF communication scheme. Also, as shown in FIG. 7, the LF communication scheme may be utilized for bidirectional communications between the EV and the smart key together with the RF communication scheme.

Specifically, the LF communication scheme uses a transmission frequency band of 125 KHz±0.5 KHz. Also, the LF communication scheme uses Pulse Width Modulation (PWM) and Amplitude Shift Keying (ASK) as a modulation scheme, and may have the frame structure shown in FIG. 13. One frame may have the length of 50 to 200 ms, and the length of each field may vary depending on the application or function of the LF antenna.

FIG. 14 is a diagram illustrating a structure of a frame used for RF communications applicable to embodiments of the present disclosure.

As shown in FIG. 14, the RF communication scheme may be utilized for the bidirectional communications between the EV and the smart key together with the LF communication scheme. The RF communication scheme may also be a communication scheme used when the IMD transmits a signal to an external device. Therefore, the RF communication module of the EV may receive and process both the signals transmitted by the smart key and the signals transmitted by the IMD.

Specifically, the RF communication scheme uses a transmission frequency band of 433.92 MHz±0.04 MHz. Also, the RF communication scheme uses Frequency Shift Keying (ASK) as a modulation scheme, and may have the frame structure shown in FIG. 14. One frame may have the length of 437.6 ms±10%, and the length of each field may vary depending on the application or function of the RF antenna.

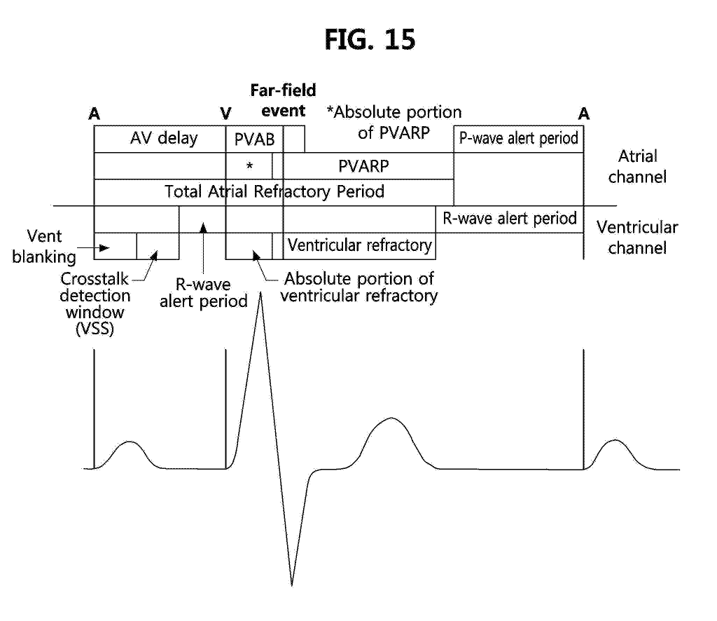

FIG. 15 is a diagram illustrating a timing cycle of a pacemaker applicable to embodiments of the present disclosure.

As shown in FIG. 15, a pacemaker, which is an example of the IMD considered in the present disclosure, may have a basic interval, a basic rate, and a ventricular refractory period (VRP) as related time elements.

The basic interval may represent an interval between two ventricular pulses or two sensed ventricular events and may be determined according to the basic rate. That is, the basic interval may be set to (60.000/the basic rate). The VRP may be a period of generating a new beating signal immediately after a previous ventricular beating, and may be from 200 ms to 250 ms.

For example, when a signal of the type shown in FIG. 15 is detected through the RF communication module, the EV according to the present disclosure may determine that the signal has been generated and transmitted by the pacemaker.

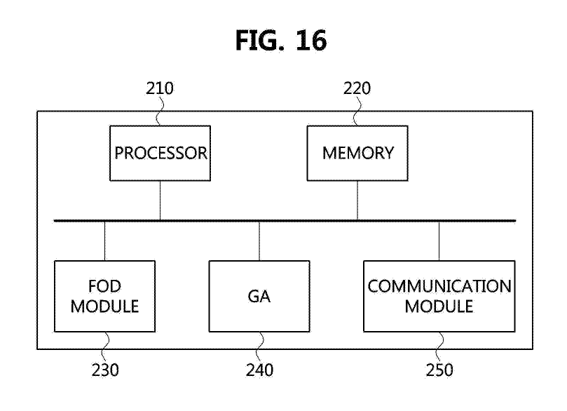

FIG. 16 is a block diagram illustrating a charging apparatus according to embodiments of the present disclosure.

As shown in FIG. 16, a charging apparatus 200 according to an embodiment of the present disclosure may comprise at least one processor 210 and a memory 220 storing at least one instruction executed by the at least one processor 210.

The charging apparatus 200 may further include a foreign object detection (FOD) module 230, a GA 240, and a communication module 250 that communicates with an EV using an LF communication scheme.

The GA 240 may be a power transfer module that includes a transmission pad coupled with a reception pad of the EV, and supplies power to the EV through the transmission pad.

The FOD module 230 may detect foreign objects around the transmission pad and the reception pad.

The at least one instruction may be configured to, when executed by the at least one processor 210, cause the at least one processor 210 to perform WPT according to a charging mode determined based on at least one of a presence of an occupant in the EV and a presence of an IMD in the EV.

The methods according to embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for an exemplary embodiment of the present disclosure or can be publicly known and available to those who are skilled in the field of computer software.

Examples of the computer readable medium may include a hardware device including ROM, RAM, and flash memory, which are configured to store and execute the program instructions. Examples of the program instructions include machine codes made by, for example, a compiler, as well as high-level language codes executable by a computer, using an interpreter. The above exemplary hardware device can be configured to operate as at least one software module to perform the operation of the present disclosure, and vice versa.

While some aspects of the present disclosure have been described in the context of an apparatus, it may also represent a description according to a corresponding method, wherein the block or apparatus corresponds to a method step or a feature of the method step. Similarly, aspects described in the context of a method may also be represented by features of the corresponding block or item or corresponding device. Some or all of the method steps may be performed by (or using) a hardware device such as, for example, a microprocessor, a programmable computer, or an electronic circuit. In various exemplary embodiments, one or more of the most important method steps may be performed by such an apparatus.

In embodiments, a programmable logic device (e.g., a field programmable gate array (FPGA)) may be used to perform some or all of the functions of the methods described herein. In embodiments, the FPGA may operate in conjunction with a microprocessor to perform one of the methods described herein. Generally, the methods are preferably performed by some hardware device.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific embodiments of the present disclosure have been presented merely for purposes of illustration and description. They are not intended to be exhaustive or to limit the disclosure to the precise forms disclosed, and obviously many modifications and variations are possible in light of the above teachings. The embodiments were chosen and described to explain certain principles of the disclosure and their practical application, to enable others skilled in the art to make and utilize various embodiments of the present disclosure, as well as various alternatives and modifications thereof. It is intended that the scope of the disclosure be defined by the claims appended hereto and their equivalents.

What is claimed is:

1. A charging control method performed by an electric vehicle (EV) configured to receive power wirelessly from a charging apparatus, the charging control method comprising:
detecting a presence of an occupant in the EV;
detecting a presence of an implantable medical device (IMD) in the EV;
determining a charging mode among a plurality of predefined charging modes according to at least one of the presence of the occupant and the presence of the IMD;
transmitting information indicating the determined charging mode to the charging apparatus,
wherein the charging apparatus activates a wireless power transfer (WPT) procedure in which power is wirelessly transmitted to the EV in accordance with the determined charging mode.

2. The charging control method according to claim 1, wherein the plurality of predefined charging modes include at least one protective charging mode for a situation in which the presence of the occupant is detected in the EV and a maximum charging mode for a situation in which the presence of the occupant is not detected in the EV.

3. The charging control method according to claim 2, wherein the at least one protective charging mode includes:
a first protective charging mode for performing the WPT procedure within a range defined by an electromagnetic safety (EMF) regulation when the presence of the occupant is detected in the EV; and
a second protective charging mode for performing the WPT procedure within a range defined by an IMD regulation when the presence of the IMD is detected in the EV.

4. The charging control method according to claim 3, wherein the EMF regulation and the IMD regulation are specified by the Society of Automotive Engineer (SAE) J2954 standard.

5. The charging control method according to claim 1, wherein the detecting of the presence of the occupant in the EV comprises:
receiving a radio frequency (RF) signal or a low frequency (LF) signal transmitted by a smart key; or
receiving a signal from a seat sensor equipped in the EV.

6. The charging control method according to claim 1, further comprising:
detecting a foreign object in an area surrounding a transmission pad of the charging apparatus or an area surrounding a reception pad of the EV; and
in response to detecting the foreign object in the area surrounding the transmission pad or the area surrounding the reception pad, stopping the WPT procedure immediately.

7. An electric vehicle (EV) comprising:
a seat sensor;
at least one communication module configured to communicate with a charging apparatus, a smart key, and an implantable medical device (IMD);
a charging module including a reception pad communicatively coupled with a transmission pad of the charging apparatus and configured to receive power wirelessly from the transmission pad through the reception pad;
at least one processor; and
a memory storing at least one instruction executable by the at least one processor,
wherein the at least one instruction is configured to cause the at least one processor to:
detect a presence of an occupant in the EV based on a signal received through the at least one communication module or the seat sensor;
detect a presence of the IMD in the EV based on a signal received through the at least one communication module;
determine a charging mode among a plurality of predefined charging modes according to at least one of the presence of the occupant and the presence of the IMD; and
transmit information indicating the determined charging mode to the charging apparatus through the at least one communication module,
wherein the charging apparatus activates a wireless power transfer (WPT) procedure in which power is wirelessly transmitted to the EV in accordance with the determined charging mode.

8. The EV according to claim 7, wherein the plurality of predefined charging modes include at least one protective charging mode for a situation in which the presence of the occupant is detected in the EV and a maximum charging mode for a situation in which the presence of the occupant is not detected in the EV.

9. The EV according to claim 8, wherein the at least one protective charging mode includes:
a first protective charging mode for performing the WPT procedure within a range defined by an electromagnetic safety (EMF) regulation when the presence of the occupant is detected in the EV; and
a second protective charging mode for performing the WPT procedure within a range defined by an IMD regulation when the presence of the IMD is detected in the EV.

10. The EV according to claim 9, wherein the EMF regulation and the IMD regulation are specified by the Society of Automotive Engineer (SAE) J2954 standard.

11. The EV according to claim 7, wherein the at least one instruction is further configured to cause the at least one processor to immediately stop the WPT procedure in response to detecting a foreign object in an area surrounding a transmission pad of the charging apparatus or an area surrounding a reception pad of the EV.

12. The EV according to claim 7, wherein the at least one communication module includes:
a radio frequency (RF) communication module configured to receive an RF signal from the smart key or the IMD and to process the RF signal; and
a low frequency (LF) communication module configured to transmit an LF signal to the smart key and to receive an LF signal from the smart key.

13. A charging apparatus comprising:
a communication module configured to communicate with an electric vehicle (EV);
a power transfer module including a transmission pad communicatively coupled with a reception pad of the EV and configured to transmit power wirelessly to the EV through the transmission pad;
at least one processor; and
a memory storing at least one instruction executable by the at least one processor,
wherein the at least one instruction is configured to cause the at least one processor to activate a wireless power transfer (WPT) procedure according to a charging mode determined by the EV among a plurality of predefined charging modes based on at least one of a presence of an occupant in the EV and a presence of an implantable medical device (IMD) in the EV.

14. The charging apparatus according to claim 13, wherein the plurality of predefined charging modes include at least one protective charging mode for a situation in which the presence of the occupant is detected in the EV and a maximum charging mode for a situation in which the presence of the occupant is not detected in the EV.

15. The charging apparatus according to claim 14, wherein the at least one protective charging mode includes:
a first protective charging mode for performing the WPT procedure within a range defined by an electromagnetic safety (EMF) regulation when the presence of the occupant is detected in the EV; and
a second protective charging mode for performing the WPT procedure within a range defined by an IMD regulation when the presence of the IMD is detected in the EV.

16. The charging apparatus according to claim 15, wherein the EMF regulation and the IMD regulation are specified by the Society of Automotive Engineer (SAE) J2954 standard.

17. The charging apparatus according to claim 13, wherein the at least one instruction is further configured to cause the at least one processor to immediately stop the WPT procedure in response to detecting a foreign object in an area surrounding a transmission pad of the charging apparatus or an area surrounding a reception pad of the EV.
